(19) United States
(12) Patent Application Publication
(10) Pub. No.: US 2020/0023519 A1
(43) Pub. Date: Jan. 23, 2020

(54) MONITORING METHOD AND MONITORING SYSTEM

(71) Applicant: KUKA Deutschland GmbH, Augsburg (DE)

(72) Inventor: Matthias KURZE, Dachau (DE)

(73) Assignee: KUKA Deutschland GmbH, Augsburg (DE)

(21) Appl. No.: 16/496,501

(22) PCT Filed: Mar. 21, 2018
(86) PCT No.: PCT/EP2018/057193

§ 371 Date: Sep. 23, 2019

(30) Foreign Application Priority Data
Mar. 29, 2017 (DE) 10 2017 106 791.4

(51) Int. Cl. B25J 9/16; B25J 13/08

(52) U.S. Cl. CPC B25J 9/1674; B25J 13/085

(57) ABSTRACT

A monitoring method for a robot. The actual internal loads are measured with a sensor at a reference point of the robot and are compared with the expected internal loads. The expected internal loads are calculated using the movement of the robot and a dynamic model. It is possible to estimate which external forces act on the robot by comparing the actual and expected internal loads. The signal characteristics of different signal components in the signal of the estimated external forces are used to differentiate between said signal components.

### CROSS-REFERENCE TO RELATED APPLICATIONS

This application is a national phase application under 35 U.S.C. § 371 of International Patent Application No. PCT/EP2018/057193, filed Mar. 21, 2018 (pending), which claims the benefit of priority to German Patent Application No. DE 10 2017 106 791.4, filed Mar. 29, 2017, the disclosures of which are incorporated by reference herein in their entirety.

### TECHNICAL FIELD

The invention relates to a method and a system for monitoring robots, in particular industrial robots.

### BACKGROUND

Accidental contact (collision) with a robot can result in large forces and thus dangerous situations. Humans and objects must therefore be protected from unintentional collisions in the vicinity of a robot. For safety reasons, people in normal industrial robot systems have no access to their work area during robot operation.

Special requirements apply to the cooperation of a robot with humans in a common work area. A distinction must be made between the mere presence of a human in the working area of the robot and the actual interaction between human and robot. In both cases, the human must be protected from collisions with the robot.

Well known are camera-based systems for collision detection for industrial robots, which trigger an emergency stop of the robot at any approach or contact by a human.

### SUMMARY

The object of this invention is to demonstrate improved robot monitoring. When operating a robot, various external forces and torques can act on the robot. Causes for external loads can arise, for example, from the process-related contact of a tool with a workpiece, from human contact or from an unexpected collision of the robot with its surroundings. Depending on the cause and type of the external load, different reactions of the robot are desired. It is therefore advantageous to detect external loads during the monitoring of a robot and to differentiate according to their cause.

The loads and internal loads mentioned in the specification and in the claims describe in a generalized sense both forces and torques in one or more spatial dimensions. A load can be any external force applied to the robot. For example, the robot is loaded when a human guides the robot arm in a conscious interaction with his hand in order to predefine a movement. A load also affects the robot, if a part of the robot or a part carried by the robot collides with its surroundings, e.g. an object, a wall or a human.

To determine the external loads on a robot, the internal loads can be viewed at a reference point of the robot. In mechanics, internal loads or internal forces and internal torques are calculated for component design. Internal loads result from a force balance of the external forces and physical reaction forces in a theoretical section of the body or a bearing.

In the internal loads, static and dynamic reaction forces from the position and movement of the mass-afflicted parts of the robot are superimposed on the robot by external loads. If the position and movement of the robot as well as its physical properties are known, the static and dynamic reaction forces and torques expected in robot operation, especially in the process, can be modeled and calculated at a specific point.

The internal loads, in particular the forces and torques, are measured at a reference point of the robot using a sensor. Detecting internal loads also means obtaining signals about the internal loads from an (electronic) interface, in particular a control unit or a sensor unit. The internal loads are preferably recorded with a force-torque sensor. The force-torque sensor is preferably installed at the reference point on or in the robot. Alternative measuring devices and measuring methods can also be used to detect the internal loads at a reference point. The reference point can be located anywhere between the frame to which the robot is attached or on which the robot stands and a moving part of the robot. The arrangement of the reference point between the robot foot and the frame is particularly advantageous, since loads can be detected at all points of the robot. In addition, a sensor can be retrofitted to the robot base of existing robots.

The robot preferably has six or seven axes of motion. The movement axes can preferably be controlled independently of each other, in particular they can be driven or blocked.

A robot state is obtained to calculate the expected static and dynamic reaction forces at the reference point. The robot state includes information on the position and/or velocity and/or acceleration of moved parts of the robot. The robot state is preferably obtained from the robot controller. The required information is usually continuously measured, estimated or adjusted for the control of the robot.

A mathematical dynamic model of the robot is used to calculate the expected internal loads at the reference point based on the position and movement of the robot. Preferably, the robot controller of the robot already has a dynamic model of the robot. Alternatively, the model can be stored in the monitoring system. If the robot changes, e.g. by changing the tool, the dynamic model can be adapted. A dynamic model typically comprises equations of movement, with which the movements of the robot are related to the acting dynamic forces.

The external forces on the robot are estimated by comparing the measured internal loads and the expected internal loads. A signal of the estimated external forces is generated. Preferably, the signals of the measured and the calculated internal forces are subtracted from each other with a comparator. The difference can be used to generate the estimation signal. It is also possible to use more complex and non-linear estimation algorithms, if necessary. The signal of the estimated external forces can contain various signal components and interference influences. The signal can also be multidimensional or have several components, e.g. for the components of forces and torques in the respective spatial dimensions. In addition, the signal can be discrete in terms of time and value. The signal can in particular be displayed by transformations in the time and/or frequency space.

One aspect of the invention is that the signal components of the estimated external forces are distinguished based on the signal characteristics. It turns out that different real loads typically have specific signal characteristics. These signal characteristics can be seen in the signal of the estimated external forces. For example, conscious human interactions with a robot typically cause a low-frequency estimation signal and unexpected collisions of the robot with objects, but also with humans, a high-frequency estimation signal. Time- or direction-related patterns in signal behavior can also characterize the signal or signal components.

The signal components of the signal of the external, estimated forces are differentiated by the signal characteristic. The distinction may be made in different ways and, where appropriate, multilevel in serial or parallel arrangement with the same signal or duplicated signals. The signal can be transformed for the distinction, for example to be examined in frequency space. Preferably, linear signal filters are used for the distinction of the signal components. Non-linear filters or algorithms for pattern recognition, which can be trained by machine learning, can also be used.

When distinguishing the signal components, known interference influences can also be taken into account. In particular, interference influences from the surroundings of the robot can be detected in the signal and in particular filtered out of the signal. The interference influences can be caused by passing vehicles or neighboring production facilities, for example, and transferred to the robot via the foundation. Known interference frequencies can preferably be filtered out via adjustable notch filters.

The distinction result is qualified with respect to the probable cause of the signal components. The qualification takes place by defined or learned rules. For qualification, deterministic or statistical methods can be used. Preferred are predefined rules, which assign certain causes to signal components in certain frequency bands. For example, signal components with high frequencies can be qualified as collisions.

Qualification can be implicitly done by arranging, adjusting or linking the elements, in particular the signal filters and/or evaluation units. The distinction result may be a filtered signal of the estimated external forces. Alternatively, new signals can be generated during distinction.

The distinction result is evaluated on the basis of defined decision rules. Through the evaluation, certain loads or situations, e.g. dangerous collisions of the robot, can be detected and/or corresponding reactions can be triggered. Preferably, the distinction result is evaluated by threshold value comparisons. If, for example, the signal level of the high-frequency signal components exceeds a limit value, the system detects an unexpected collision and can trigger an emergency stop of the robot.

If certain external loads are detected in the distinction result, a control signal can be generated for the robot or a certain operating mode of the robot can be triggered. If necessary, the control signal can be sent to the robot controller via an interface. The control signal can trigger an event or contain control information for the robot. Based on the signal characteristics, the control signal can contain, for example, a movement instruction to move the robot arm back. In particular, a control signal can be generated, when a collision of the robot is detected.

External forces from conscious human interactions can cause a different or no control signal.

The distinction of the signal components on the basis of the signal characteristics of the estimated external forces offers the advantage that the monitoring method can be used during a human robot collaboration (HRC), in which the human interacts consciously with the robot by contact. The monitoring system can distinguish conscious human interactions from unexpected collisions. Thus, collision monitoring can also be active during human interaction with the robot. In particular, collisions can be detected while a human is guiding the robot. This can be advantageous if, for example, the operator is startled by the hand movement of a robot arm and performs a sudden movement. Especially if the robot supports the guiding movement with a force by its drive, such a collision detection is advantageous during an interaction. In such a case, the monitoring system can detect the sudden reaction using the signal characteristics and slow the robot movement or generate another control signal.

The decision rules for the detection of certain loads can be adjusted during an application phase of the system, during a learning session or during current operation. The monitoring system may have a processor and an electronic memory in which the monitoring method is stored as a data processing program.

The forces generated on the robot during the execution of a manufacturing process, in particular with a tool, can be taken into account in the monitoring method. For example, a tool attached to the robot can include moving parts that exert forces on the robot and have a specific signal characteristic. Even when a tool comes into contact with a workpiece in the manufacturing process, for example a folding process, forces can act on the robot that have a certain signal characteristic and are detected by the monitoring method.

The robot monitored by the monitoring system can be operated in different operating modes. For example, the robot can be operated in an automatic mode, a collaboration mode, an interaction mode, a collision mode and/or an emergency stop of the robot. The axes of the robot can be position- or force-controlled. In particular, the invention can improve a cost-effective robot with position-controlled axes and add new functions. In automatic mode, the robot can perform a stand-alone process, especially a high-speed manufacturing process. If a human enters the work area, further safety requirements must be observed. For example, the robot can be moved more slowly in a collaboration mode. As soon as the human touches the robot, the interaction can be detected and/or an interaction mode can be triggered. In an interaction mode, for example, the axes of the robot can be soft-switched, so that the human can control the movement of the robot.

If an unexpected collision is detected, a collision mode can be triggered at low force intensity, in which the robot, for example, cautiously recedes or slows down.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic representation of the monitoring method with a monitoring system.

### DETAILED DESCRIPTION

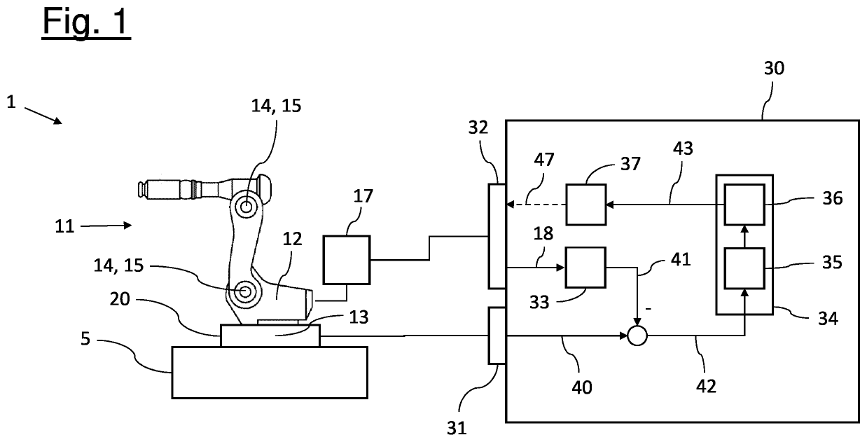

FIG. 1 shows a schematic representation of a monitoring system (30) for monitoring a robot (1) with a force-torque sensor (20) between the robot foot (12) and a frame (5) of the robot. A schematic signal flow of a possible embodiment is shown. The monitoring system (30) receives a signal of the measured, actual internal loads (40) at the reference point (13) via a sensor interface (31). The actual internal loads are compared with the expected internal loads (41). The external forces are estimated and a signal of the estimated external forces (42) is generated. The expected internal forces (41) are calculated by a dynamic unit (33) with a mathematical dynamic model of the robot.

In this preferred embodiment, the distinctive unit (34) comprises two linear signal filters. A high-pass filter (35) suppresses low-frequency signal components. A notch filter (36) suppresses known, especially learned, interference frequencies. The distinction result (43) does not include any low-frequency signal components due to human interactions as a result of filtering.

By means of a threshold value comparison, an evaluation unit (37) recognizes in the distinction result (43), in this case the filtered signals of the estimated external forces, whether there is an unexpected collision of the robot (1). If a specific threshold value in the level of the distinction result is exceeded, a control signal (47) can be generated. The control signal can be transmitted via a robot interface (32), in particular to a robot controller (17).

A robot (1) can have any number and combination of rotatory- and/or translationally-driven robot axes. The robot (1) comprises a movable robot arm (11), a robot foot (12), at least one linear or rotating motion axis (15) and a robot controller (17). An industrial robot (1) can stand on a frame (5) or directly on a foundation with a robot foot (12). Alternatively, the robot (1) can also be suspended from a frame (5). The robot (1) is supported against its surroundings by a robot foot (12) on a frame (5). The robot foot (12) has suitable fastening means to be fastened directly to a frame (5) or to a sensor (20). The sensor (20) can also be retrofitted as a force-torque sensor on robots which were previously mounted directly on a frame (5). The sensor (20) is arranged with suitable interfaces between robot foot (12) and a frame (5) or foundation.

The reference point (13) for measuring the internal loads with a local sensor (20) can be located at different points on the robot. Preferably, the reference point is between the robot foot (12) and a frame (5). In this preferred embodiment, all loads on the robot can be detected in the internal loads. Alternatively, the reference point can also be located between two moving parts of the robot arm (11) or between the robot arm (11) and the robot foot (12).

The robot (1) comprises a monitoring system (30). The monitoring system may be part of the robot controller (17).

According to a first embodiment, the monitoring method is carried out by a monitoring system (30), which communicates with a robot controller via a robot interface (32).

According to an alternative version, the monitoring system can be implemented in the controller of the robot controller and exchange signals with other parts of the robot controller via internal interfaces.

A particularly interesting application of the invention lies in the production of different variants, whereby one variant is produced much less frequently than the other. Here it can be economically advantageous to operate the robot only for the frequent variants in a preprogrammed manufacturing process in automatic mode. For the production of the rare variants, the robot can be guided by an operator. The robot switches to an interaction mode. This reduces the effort for programming the robot. The profitability of the robot system is thus improved.

Modifications of the invention are possible in different ways. In particular, the features shown, described or claimed for the respective embodiments can be combined with each other in any way, replaced against each other, supplemented or omitted.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
5 Frame
11 Robot arm
12 Robot foot
13 Reference point
14 Joint
15 Motion axis
17 Robot controller
18 Robot state (signal)
20 Sensor; force-torque sensor
30 Monitoring system
31 Sensor interface
32 Robot interface
33 Dynamic unit
34 Distinction unit
35 Signal filter; high-pass filter
36 Signal filter; notch filter
37 Evaluation unit
40 Actual internal loads (signal)
41 Expected internal loads (signal)
42 Estimated external forces (signal)
43 Distinction result
47 Control signal

What is claimed is:

1-19. (canceled)

20. A method of monitoring a robot, comprising:
detecting actual internal loads at a reference point of the robot with a sensor at the reference point;
obtaining a measured or estimated robot state, wherein the robot state comprises at least one of a position, speed, or acceleration of moving parts of the robot;
calculating expected internal loads at the reference point from a mathematical dynamic model of the robot and the obtained robot state;
estimating external forces on the robot based on a comparison of the expected internal loads and the actual internal loads;
distinguishing different signal components of the estimated external forces on the basis of a signal characteristic;
wherein distinguishing the different signal components comprises detecting certain external stresses on the basis of defined decision rules; and
qualifying the distinction result with respect to the probable loading cause of the signal components.

21. The method of claim 20, wherein at least one of:
the reference point is a point between a foot and a frame of the robot;
the reference point is at a joint of the robot;
the sensor is a force-torque sensor; or
different signal components are distinguished on the basis of a frequency characteristic of the signal.

22. The method of claim 20, wherein detecting certain external stresses comprises detecting conscious human interactions or unexpected collisions of the robot with objects or humans.

23. The method of claim 20, further comprising:
generating a control signal for the robot or triggering a certain operating mode of the robot in in response to detecting a certain external load in the distinction result.

24. The method of claim 20, further comprising:
filtering the signal of the estimated external forces with one or more signal filters in order to distinguish the various signal components.

25. The method of claim 20, further comprising evaluating the distinction result by a threshold value comparison.

26. The method of claim 20, wherein obtaining the measured or estimated robot state comprises obtaining the robot state for a tool or another attachment of the robot.

27. A monitoring system for a robot, comprising a computer including computer code stored in a non-transient computer-readable storage medium, the computer code configured, when executed by the computer, to cause the computer to:
detect actual internal loads at a reference point of a robot with a sensor at the reference point;
obtain a measured or estimated robot state, wherein the robot state comprises at least one of a position, speed, or acceleration of moving parts of the robot;
calculate expected internal loads at the reference point from a mathematical dynamic model of the robot and the obtained robot state;
estimate external forces on the robot based on a comparison of the expected internal loads and the actual internal loads; and
distinguish different signal components of the estimated external forces on the basis of a signal characteristic.

28. The monitoring system of claim 27, wherein the monitoring system is configured for human-robot collaboration and adapted to detect unexpected collisions of the robot to be monitored and to distinguish the unexpected collisions from conscious interaction of a human with the robot.

29. The monitoring system of claim 27, wherein the monitoring system is configured as a separate control unit or implemented in a robot controller of the robot.

30. The monitoring system of claim 27, further comprising a sensor interface for exchanging signals with a sensor.

31. The monitoring system of claim 30, wherein the sensor is a force-torque sensor.

32. The monitoring system of claim 27, further comprising a robot interface configured to exchange signals with the robot or its robot controller.

33. The monitoring system of claim 27, further comprising a dynamic unit adapted to obtain the robot state and to calculate the expected internal loads at the reference point using a mathematical dynamic model of the robot.

34. The monitoring system of claim 27, further comprising a distinction unit adapted to distinguish or separate signal components in the signal of the estimated external forces on the basis of the signal characteristic.

35. The monitoring system of claim 34, wherein the distinction unit comprises signal filters.

36. The monitoring system of claim 27, further comprising an evaluation unit adapted to detect certain external loads on the robot based on the distinction result.

37. The monitoring system of claim 27, wherein the monitoring system is configured to at least one of:
generate a control signal in response to a certain external load; or
trigger a certain operating mode of the robot [in response to the distinction].

38. An industrial robot, comprising:
a movable robot arm supported on a robot foot for movement about at least one linear or rotating movement axis, and a robot controller controlling movement of the robot arm;
the robot foot configured to be fastened on a frame;
a sensor configured to calculate at least one of the internal forces or torques at a reference point between the frame and a part of the robot arm; and
a monitoring system configured to:
detect actual internal loads at a reference point of a robot with a sensor at the reference point,
obtain a measured or estimated robot state, wherein the robot state comprises at least one of a position, speed, or acceleration of moving parts of the robot,
calculate expected internal loads at the reference point from a mathematical dynamic model of the robot and the obtained robot state,
estimate external forces on the robot based on a comparison of the expected internal loads and the actual internal loads, and
distinguish different signal components of the estimated external forces on the basis of a signal characteristic.

39. The robot of claim 38, wherein the robot is configured to operate in at least one of an automatic mode, an interaction mode, or a collision mode.
